(19) United States
(12) Patent Application Publication
(10) Pub. No.: US 2021/0409464 A1
(43) Pub. Date: Dec. 30, 2021

(54) Visit Via Taker Method and System

(71) Applicant: Abraham Varon-Weinryb, Waltham, MA (US)

(72) Inventor: Abraham Varon-Weinryb, Waltham, MA (US)

(21) Appl. No.: 17/360,756

(22) Filed: Jun. 28, 2021

Related U.S. Application Data
(60) Provisional application No. 63/045,333, filed on Jun. 29, 2020.

(51) Int. Cl. H04L 29/06

(52) U.S. Cl. CPC H04L 65/4015

(57) ABSTRACT

The present invention provides method and system for integration of virtualization within real life, in which an interaction between two persons enables a customer to remotely and proactively visit, experience, participate, explore, find, verify, preview, plan, share, and get assistance with various goals, by using a specialized software application.

### CROSS REFERENCE TO RELATED APPLICATIONS

This application claims benefit of provisional application 63/045,333 filed on Jun. 29, 2020.

### FIELD OF THE INVENTION

The field of the invention relates to a method and system of video streaming and of services via the internet.

### BACKGROUND OF THE INVENTION

The modern world integrates the internet with physical actions, so that many activities can be initiated and arranged using the internet via applications. For example: ordering a restaurant meal over the internet, order a taxi over the internet, etc.

Another available technology over the internet is a video streaming which allows video conferencing between people, live streaming of concerts via the internet, video chat over social networks etc.

Yet another usage of video streaming is the ability to provide online services such as psychology therapy over the internet or learning to play a guitar with a teacher over the internet.

The above items demonstrate a certain level of technology maturity which allows such remote activities over the internet. However, all these activities represent only a tiny of the real potential and of the real need of which the object of the present invention is to fulfill.

It is therefore an object of the present invention to provide an integrated method and system which make a quantum leap in the integration of virtualization within real life, and in which a transaction between one person to another person enables a customer to visit, experience, participate, explore, find, verify, preview, plan, share, get assistance with small or big things and more.

It is an object of the current invention to provide a specialized software application and a specialized infrastructure to enable the best possible experience of said virtual experiences.

It is a particular object of the present invention to use ideograms as means to transfer instructions in real-time. Unlike emojis, such ideograms are not used to transfer emotions, but to transfer specific instructions in a very convenient way which also overcomes possible language barriers.

It is yet another object of the present invention to enable take-over operations in which one person via one device activates software and hardware of another person and such another person's device.

It is yet another object of the present invention to provide a feedback system to a person which analyses a product created by said person, and possibly sensors' data from said person's mobile device, and possibly instructions provided by another person to said person via ideograms or otherwise, for the purpose of teaching said person how to improve said person's product.

### SUMMARY OF THE INVENTION

The invention relates to A computer implemented method for remote or virtual visits over the internet, comprising the elements of: (a) A Matched Visitor's app running on said Visitor's device and enabling said Visitor to remotely and actively participate in a remote visit, farther described as “Visit”; (b) A Matched Taker's app running on said Taker's device and enabling said Taker, who takes said Visitor to a Visit, to communicate with said Visitor and to live-stream said Visit products to the Visitor; and (c) A Server enabling the real time communication or a short delay communication between said Visitor's app and said Taker's app;

Preferably, said Visitor's app includes Control Icons and said Taker's app provide visual indication resulting of operating said Control Icons at the Visitor's end.

Preferably, sound or voice alerts are initiated at the Taker's app resulting of operating Control Icons at the Visitor's app.

Preferably, said Visitor's app includes Take Over Icons and said Taker's app activates software and hardware element directly at the Taker's device as a result of operating said Take Over Icons at the Visitor's end.

Preferably, said server includes a Video Analyzer which analyzes parameters of the video stream.

Preferably, the method farther comprises a Video Normalizer which improves the quality of said video based on said Video Analyzer's analysis prior to forwarding said video to the Visitor's app.

Preferably, the method farther comprises an Analyzer, and such Analyzer provides feedback to the Matched Taker in order to enable the Taker to improve the quality of such taker's video streaming.

Preferably, said Analyzer uses the instructions provided by the Matched Visitor as part of the Analyzer's analysis.

Preferably, sensors or orientation data at the Taker's device are used as part of the Analyzer's analysis.

Preferably, said Visit is initiated by said Visitor who defines the desired place and time of the Visit.

Preferably, additional requirements are included in the initiated Visit such as mobility mode or end point's location or duration or language or special requests for special activities to be fulfilled as part of said Visit.

Preferably, said Visit is suggested by said Taker and such suggestions can be browsed or filtered or searched and selected by said Visitor via said app or a dedicated website.

Preferably, said Control Icons include instructions to move forward or move backward or move left or move right or rotate device or stop or focus or cancel focus.

Preferably, said Take Over operations operate the Taker device's camera.

Preferably, said Take Over operations operate an external device of the Taker.

### BRIEF DESCRIPTION OF THE DRAWINGS

In the drawings:

FIG. 1 is a generic diagram of the invention, illustrating the flow according to the method and system of the invention.

FIG. 2 is an example for an interface used by a Visitor to initiate, define and schedule a Visit according to the invention.

FIG. 3A illustrates a specific example of ideogram used as Control Icons, as part of an example of the application's Graphic User Interface and derived functionality according to the invention.

FIG. 3B is illustrates a specific example of Take Over Icons, as well as an example of Post-Processing Icons, as part of an example of the application's Graphic User Interface and derived functionality according to the invention.

FIG. 4 is an example for a web page in which a visitor can browse, filter, search and sort suggestions of visits initiated by takers according to the invention.

### DETAILED DESCRIPTION OF PREFERRED EMBODIMENTS

The method and system according to the invention enables a person to virtually visit any place in the world which such person wants to visit, at any date and time desired by such person, farther described as a “Visit”. It also enables the person to be involved in endless types of activities, as further described, all according to the invention, thus the Visit may be active and fulfill tasks and goals.

In order to virtually be at any desired place in the globe at any desired time, and to be able to see, to hear, and to possibly be farther involved in various activities, a person according to the invention, farther described as a “visitor”, needs to find another person, farther described as a “taker”, who will take care for the visitor and fulfill said visitor's wishes by virtually taking the visitor to the desired place at the desired time and possibly also assist such visitor with specific tasks as required by said visitor.

In order to find such taker, the visitor needs first to define the visitor's goals, comprised of several basic definitions and optionally some additional definitions. Such definitions will be defined using a special application according to the invention or via a website in which such application is embedded or to which such application is connected via a database on a server. Said application and website may run on a mobile device, a computer, a smart television, or similar devices. Said basic definitions provided by the visitor include:
a. Where: the visitor defines a place which he wants to virtually be in. Embedding an existing maps system such as Google Maps or similar into said app or said website will make the process easy to implement and easy to use. The user enters an address or a point-of-interest and the auto-fill/auto-suggestion of such embedded map system may help the visitor to complete the input and, once the input is completed, also to see the target location on a map, all according to such embedded map system's common practice.
b. When: Two options are possible. Option (b1): the visitor selects “NOW”. This means that the visitor wants to have the Visit as soon as possible. Option (b2): the visitor browses or types a date and a time.

While said (a) and (b) definitions of where and when are considered to be the minimal set of definitions, the user may add additional definitions. However, it should be noted that some of such additional definitions might already be defined in a pre-defined profile of a user's account of such visitor. As common with many applications, the visitor will sign up before first use, and sign in before any additional use. Once signed in the visitor can make or modify some default definitions in his profile. Such default definitions can be used as some of said additional definitions, unless the user overrides them with other parameters.

Said additional definitions which can optionally be provided by the visitor may include:
c. Language or languages: This will allow a proper voice and chat communication between the visitor and the taker. This definition is also an example for something that would be best to enter in the user's profile of the visitor, such that in most cases the visitor does not need to override and re-enter such definition.
d. Travel by: This defines the way the visitor wants the taker to move from one point to another, which is defined as a Mobility Mode according to this invention. Possible such mobility modes could be “walking”, “cycling”, “driving”, and even “flying”. Optionally it could be a combination of two or more options. This is something that could also be predefined in the user's profile as the default for said user. For example, if the visitor defines “walking” in his profile, this will remain the mobility option for all future visits unless the visitor overrides this option with another mobility mode option.
e. End Point: The definition (a) above refers to a specific location. However, the visitor may create a route by also adding an end point. Such end point will be entered by means of address or of point-of-interest, using the same process as described in (a) above. Once the end point is entered, the visitor sees the start point and the end point on said map, as well as a suggested route between the two points which is based on said Mobility Mode as described in (d) above. For example, a walking route if such mobility mode is walking.
f. In between points: The user may add in between point or points that will be added to said defined route and dictate desired constraints attached to the Visit from said start point to said end point. However, such details may be provided to the taker, at a later phase in a real time via means of talking, chatting or by use of control icons, as farther described in the following description and examples, all according to the invention.
g. Requested Duration: The user may define the estimated time he would like for the Visit to take. This is important especially if the visitor plans for a relatively long visit's duration, since the taker should be aware and prepared for such long visit.
h. Special requests: The visitor may add special requests as part of the Visit plan. There are endless options here are and some will be farther explained in the following description and examples. This means that the method and system according to the invention supports not only a passive Visit but also an active Visit in which many types of specific activities and tasks, as required by the visitor, may be fulfilled.

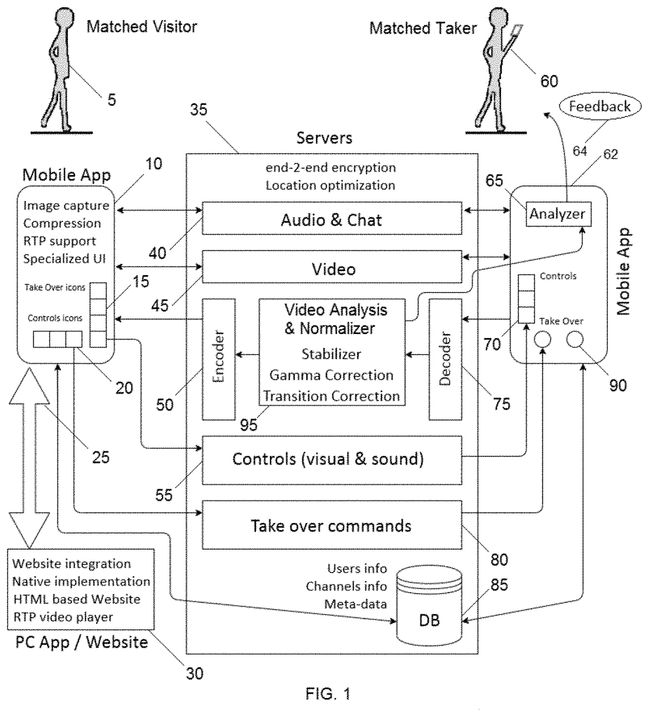

Once the visitor completes the desired visit's definition, a process of matching is done, in which available takers that meet the requirements are suggested to the visitor. Such matching process is farther described in a separate patent application. After receiving the list of available takers, which include takers' rating and suggested pricing for the Visit, as farther described in said separate patent application, the visitor selects a specific taker. The selected taker is being informed and confirms the visit. At this point, said visitor who has got the confirmation and said selected taker are defined as a Matched Visitor (5) and a Matched Taker (60) according to the invention, as described in FIG. 1. and farther described also as “Taker” and “Visitor”. At the start time (b) the Taker need to be located at the starting point, described as (a) above. The Visitor and the Taker must both sign-in to a special application which is developed according to the invention, farther described as the “Take a Taker application” or “Takeataker app”. At the Taker's side, said Takeataker app is installed and running on such Taker's mobile device 62, as shown in FIG. 1. At the Visitor's side, said Takeataker app is installed and running on such Visitor's mobile device (10) or on such Visitor's computer (30) or TV (30). The Takeataker app may be a standalone app or an embedded application in a browser via a Takeataker Website which is developed according to the invention. If embedded in said website, the Takeataker app can be used via a standard browser, all according to common practices of embedding applications in websites and running them via browsers. There are two main modes to sign in to the Takeataker app. One mode is a Visitor mode, and the second mode is a Taker mode. The functionality, the GUI and the behavior of the Takeataker app may be different for each of said main modes. When a person signs up to use the Takeataker app for the first time, he needs to define whether he wants to sign up as a Taker or as a Visitor or as both. If a person is signed up as both, any time such person signs in he needs to define whether he signs in as a Visitor or as a Taker.

Once the Visitor is signed-in as a visitor and the Taker is signed-in as a taker, and the taker is located at the start point at the start time, they initiate a connection via the Takeataker app, which is a dedicated connection between a Matched Taker and a Matched Visitor. As farther described, it is possible to make a session that connects one Matched Taker to several Matched Visitors if this is the way such session is defined and ordered.

Once the connection between the Visitor via the visitor's mobile device (10) or computer (30) and the Taker via the taker mobile device (62) is established, the Visit may start. The visitor and the taker can choose, via the takeataker app's menus, to communicate with each other via voice conversation (40) and via chat (40). They can also turn on and off a video conversation (45), in which the Taker's front camera which is at the screen side of the device (62) is used. The takeataker app is using the main camera at the back side of the taker's device to capture a high-quality video, which is the main video streaming. A 5G cellular network will enable maximal video quality and performance. When and where 5G is not available, a lower video resolution will be used to support a timely video streaming.

Once the Takeataker app at the Taker's side captures said video, it compresses it and optionally encrypts it, and uploads it via the cellular network to a Takeataker's nearest server (35). The server (35) uses a Decoder (75) to extract the video. Then the video's quality can be improved using a Video Normalizer (95). Then the video is compressed again and optionally encrypted again using the server's encoder (50) and transmitted to the Takeataker app at the Visitor's side.

While the Visitor sees the main video streaming at his side, he may talk (40) to the Taker and instruct him where to go, when to stop, where to turn etc. Another way is to chat (40). Yet another special way to communicate according to the invention: The Visitor can use special ideograms as means to transfer instructions to the taker in real-time according to the invention. Unlike emojis, such ideograms are not used to transfer emotions, but to transfer specific instructions in a very convenient and immediate way which also overcomes possible language barriers. These specialized ideograms are also referred to as “Control Icons” according to the invention and marked (20) at the Visitor's side and (70) at the Taker's side. They can also be customized, meaning that said Control Icons can be added or removed to the app's interface. Such Control Icons can provide real time instruction instead of talking to the taker, and this is a very intuitive and comfortable way to communicate. For example, a Control Icon with a drawing of a stop sign can be used to instruct the Taker to stop moving. If the Visitor presses said icon, it will pop up at the Taker's side. Alternatively, such icon may already be visible at the Taker's side and when the Visitor presses such icon it will change its color at the Taker's side or will be highlighted at the Taker's side. In addition, a specific sound can be activated at the Taker's device to alert that a Control Icon has been activated, and optionally a corresponding voice command can be heard, e.g. saying “STOP”, at the Taker's side. The information relating to the Control Icons is communicated via a server's unit (55) which transfers said Control Icons information from the Visitor's side to the Taker's side as part of the data transfer protocols used to transfer said information over the internet. Additional example of Control Icons will be shown below at the examples' chapter.

Another type of operations can be achieved via Take Over Icons (15). These are buttons at the Visitor's side of the Takeataker app, which allow the Visitor to take over some of the functionality at the Taker's device, and to perform specific operations. This means that the Visitor (5) can make directly certain operations with the mobile device (62) of the Taker, without any involvement of the Taker (60) in such operations. For example, a Take Over Control Button (15) marked as “snapshot” will allow the Visitor to directly operate the camera of the Taker's device (62) to take snapshot pictures which will be transferred from the Taker's device via the Take Over Operations unit (80) at the server to the Visitor's device (10) or (30). The Taker may have a visual indication (90) at the Takeataker app, informing the Taker that Take Over operations are being executed.

The main video streaming which is transferred from the Taker's device to the Visitor's device via the Takeataker server (35) can be decoded (75), analyzed and normalized at the Video Analysis & Normalizer unit (95), and then encoded again (50) before being transferred over the internet to the Visitor's device. The Video Analysis & Normalizer (95) farther also referred to as VAN, has two purposes: (a) Analysis of the quality of the video product which the Taker is producing, based on various parameters such as frames' stability, smooth zoom in/zoom out operations etc. Such analysis can be used for several purposes: (al) Rating or scoring the job done by the Taker, which will be part of an overall rating of the Taker. This rating will be stored at the server's Data Base (85). Some other parts of the Taker's rating will be based on direct rating provided by the Visitor at the end of the Takeataker session. (b1) Using said analysis to provide a set of suggestions that allow the Taker to learn how to improve the quality of the video which such Taker produces. For that purpose, the analysis data of the VAN unit (95) is sent to the Analyzer (65). The Analyzer provides feedback (64) to the Taker. Such feedback may be voice instructions or graphic visual instruction or written instructions. Such feedback may be provided in real time during the Visitor-Taker session, or at a later time, after the session. The Analyzer (65) may use combined data which may include (I) data from the VAN (95) as well as (II) data from the sensors of the Taker's device as well as (III) the instructions provided by the Visitor. If, for example, the Visitor asks the taker to turn left, the Analyzer may use the video product itself as well as said sensors' data to analyze the parameters of the Taker's responsiveness: Has the Taker responded? Was the respond fast enough? How smooth and professional the video transition was during said left turn? and so on. In addition to providing feedback (64) to the Taker, said combined data and related derived said feedback may also be used to provide scoring that will be part of said Taker's rating.

To prevent confusion, it should be noted that the Video unit (45) in the server, which is bi-directional, refers to a video chat between the Taker and the Visitor, in which the Taker uses the front camera of device (62) and the visitor uses the front camera of device (10) or a web camera of device (30). The main video product, however, which is generated by the Taker's main camera, is the video transferred from the Taker to the Visitor via the Decoder (75), the Video Analysis and Normalizer (95) and the Encoder (50).

The following are notes re masking, security and privacy.
(a) The identity of a Matched Visitor is unknown to a Matched Taker as a default. When a visitor defines a profile, such visitor enters full details including real name, payment details etc. All such details are stored at the server's data base (85) but are not provided to the Matched Visitor. The Matched Visitor only gets a nick name which the Visitor has chosen to include in said Visitor's profile, and possibly a unique ID of the visitor within the Takeataker database (85), and also a unique ID of the specific planned Visit between said Matched Visitor and said Matched Taker. No personal private information whatsoever is transmitted to the Taker by the Takeataker app.
(b) The videos and the snapshots taken during the Visit will not be stored at the server's DB (85) after the Visit session ends.

The method of the invention will be farther explained and demonstrated hereby with various examples.

### Example 1

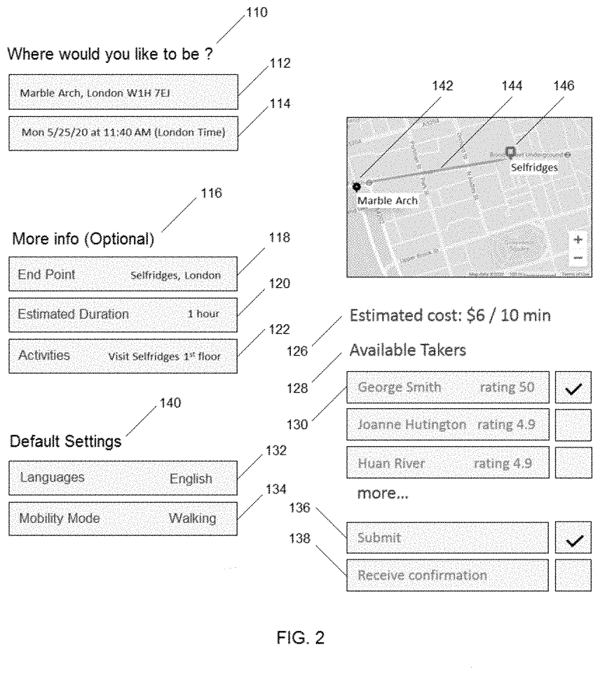

FIG. 2 shows an example of a form-like interface that will be part of the Takeataker application or part of the Takeataker website, and will be used by a Visitor, once signed in, to define, schedule and secure a Visit with a Taker.

The first section (110), defined as “Where would you like to be?”, includes two must have fields:
(a) “Where” field. In this example the user entered “Marble Arch” in London. The search auto suggestion of the embedded map system completed the address. Alternatively, the visitor could enter the street address of Mable Arch, which is 987 Oxford St, London. The location is displayed (142) on the embedded map.
(b) “When” Field. In this example the day of May 20, 2020 has been browsed or entered directly and a time of 11:40 London time has been browsed or entered directly. It should be noted that in case the user would like to have a Visit as soon as possible, even almost immediately if possible, he may choose “NOW” instead of browsing a data and a time. The system according to the invention will try to find takers which are available immediately or almost immediately.

The second section (116), defined as “More info (Optional)”, includes in this example three fields:
(c) “End Point” field. In this case the visitor wants to define not only a location under (a) above, but also an end point—in this example the Selfridges store in London (118). This is shown on the map (146). The route between the two locations is also shown (144). The route is based on the current default Mobility Mode as explained hereby at item (g) below.
(d) “Estimated Duration”. In this case, the visitor wants to specify the estimated desired duration of the Visit, in this example 1 hour (120). Typically, a Visitor should enter a desired duration if it is a relatively long duration or if it is specifically longer then the implied duration according to said planned route.
(e) “Activities”. In this example the visitor has a special request for a specific activity. In this case the visitor wants to visit the first floor of the Selfridges department store (122). It could be, for example, that the visitor would like the taker to take a video of specific new items in the store, and perhaps the visitor wants to take a snapshot of such items and their price-tags. This illustrate the fact that Visits by takers according to the invention are not limited to a passive viewing and hearing but may also include specific active tasks and goals that could be achieved during a Visit. This is farther demonstrated in example 3 below.

The third section (140), defined as “Default Settings”, includes in this example three fields which are pre-defined by the visitor at the visitor's profile in the visitor's account:
(f) “Languages” field (132). In this example the user entered “English” during the profile definition. This can also be modified whenever signing-in.
(g) “Mobility Mode” (134). The visitor defined “Walking”, and this is will be type of any Visit defined, unless modified. Said route (144) as indicated at the map is based on the current mobility mode.

Once entering the data for said three sections (110), (116), (140), the visitor gets the following results on the screen:
(a) Cost for the desired visit (126).
(b) A list of available takers and their corresponding ratings (130).

In this case the user check boxed the first taker in the list—“George Smith”. Then the user pressed the Submit button (136) and a check box appeared, indicating that the Visit has been submitted. Now the visitor awaits to receive confirmation from the taker (138). Mr. George Smith will receive the visit request and will need to confirm it. If he confirms, the visitor receives a confirmation check box and the Visit is secured and ready to start at the planned time while the taker will be located at the planned location. If something has changed at the taker's side and he cannot confirm the Visit, the visitor will receive a notification and will be asked to select another taker from the list (128) of available takers.

One a requested Visit gets a confirmation the Matched Visitor and the Matched Taker are listed in the system database (85) as shown in FIG. 1 and are prepared to start the visit when scheduled. The matching method that links a visitor and a taker for the purpose of securing a Visit between a Matched Visitor and a Matched Taker is farther described and developed in a separate patent application.

### Example 2

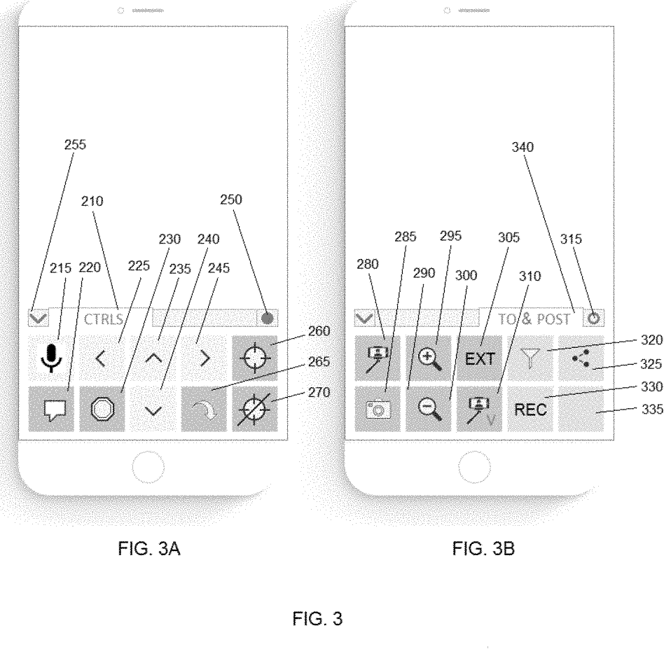

FIG. 3 shows an example for the Graphic User Interface of the Takeataker app, and corresponding functionality. In this example, the following GUI principles are applied:
(a) A group of 10 icons is displayed on the bottom side of the screen. It is possible to switch to another group of 10 icons by selecting a different tab or by sweeping the touch screen to the right or to the left over the GUI. Said two selectable tabs are marked as the CTRL tab (210) and the TO&POST tab (340).
(b) Another principle of the GUI in this example is that it is customizable, meaning that each user can customize the application by receiving a list of icons and the operations they represent, and select which icons he needs to be visible and where to place such icons in the GUI. For example, icon (280) in FIG. 2B is an icon for a take-over selfie operation, which will be farther discussed and explained. However, if a specific visitor has no intentions whatsoever to take selfies, such visitor may use the customizable approach to remove such operation from the GUI and to place another icon instead which is used for a different operation.
(c) The same GUI basically is used for both a visitor and a taker in this example, making the GUI environment easy and comfortable for people that are signed up as both a visitor and as a taker, and may wish to sign in sometime as a visitor and sometime as a taker. Such people having a dual profile will be able to customize the system for each of said operation modes, so that when they sign in as a visitor their visitor's customized GUI will be displayed and when they sign in as takers their taker's customized GUI will be displayed.
(d) Whenever a connection between a Matched Visitor and a Matched Taker is established, the Matched Visitor customized GUI will override the Matched Taker customized GUI, if and where needed, all according to this example. For example, if a Control Icon (205) which indicates a device rotation exists at the visitor's side, it must exist at the taker's side as well.
(e) According to this example, the entire GUI can be removed and brought back by sweeping the touch screen down or up over the GUI, or by pressing the toggle button (255). If the GUI is removed, the video area is maximized. In such case the GUI pops up by the user upon need or pops up automatically when needed—for example to present a new instruction to the taker by means of a new Control Icon display or highlight, all according to the functionality of control Icons.
(f) If a user toggles the pin icon (315), the GUI will be always visible.

FIG. 3A shows an example of a typical set of Control Icons. When a Control Icon is selected by a Matched visitor during a Visit session, the same Control Icon will be displayed or selected or highlighted or enlarged at the Matched Taker's side, for a predefined amount of time, or until replaced with a new Control Icon, providing instruction by means of the Control Icon which is a kind of ideogram. This may be accompanied by an alert sound or a specific voice instruction which is associated to said selected ideogram. For example, a voice saying: “Move forward”.

The following is a list of the Control Icons in this example:
(a) Move forward (235)
(b) Turn left (255)
(c) Turn right (245)
(d) Go back (240)
(e) Stop (230)
(f) Focus on item (260). When this icon is pressed by the Visitor, he needs to make a simple free drawing of an “x” or a circle on the screen, pointing something in the video that the Visitor asks the Taker to focus on. For example, if a Taker is going in the street and there is a street show of an acrobat, the Visitor may want the Taker to focus on that acrobat while moving forward in the street, towards the acrobat.
(g) Cancel focus (270)—to stop said focusing.
(h) Rotate (265)—The visitor asks the taker to rotate the taker's device, i.e. to change to a portrait orientation if it is currently a landscape orientation and vice versa.

The Control Icons tab, also marked as “CTRLS” (210), as shown in FIG. 3A, also includes in this example two icons which are not Control Icons but simply icons to initiate a voice conversation (215) between the Visitor and the Taker or to initiate a chat (220) between the Visitor and the Taker.

FIG. 3B shows an example of a typical set of Take Over icons and Post Processing icons. When a Take Over Icon is selected by a Visitor during a Visit session, the Visitor is taking over a specific functionality of the Taker's device and performs an operation directly at the Taker's end. This may be accompanied, at the Taker's side, with an alert sound or a specific voice-notice or a specific visual indication to make the Taker aware of such take over operation. Such awareness will not only make the Taker feel more comfortable but also enable the Taker to support the operation with an appropriate behavior. For example, if the Taker sees that the visitor is taking over the Taker's camera for a stills snapshot or for a selfie, the Taker may stop walking even if the visitor forgot to ask the Taker to stop by using a Stop Control Icon or by a request using voice or chat communication.

The following is a list of the Take Over Icons in this example:
(a) Snapshot (285). The Matched Visitor takes over the snapshot functionality of the Taker's back camera and takes a picture. The picture, once taken, is transferred to the Visitor's device which is marked (10) or (30) at FIG. 1 and is stored there. It is not stored at the Taker's device which is marked (62) at FIG. 1 and it is not stored at the server, which is marked (35) in FIG. 1.
(b) Selfie (280). This will make the following steps: (b1) take a snapshot using Take Over operation as described in (285) above; (b2) take a selfie snapshot of the Matched Visitor using the front camera of the Visitor's device; (b3) Using image algorithms extract the Visitor's image from (b2) and place it on top of (b1) to imitate a selfie taken by the Visitor at the Visit's location. In other words, it integrates a picture taken at the Visitor's device with a picture taken at the Taker's device; (b4) Enable the Visitor to see the resulted selfie snapshot, to keep it, to delete it, all during the Visit session or after the Visit session.
(c) Video Selfie (310). Similar to Selfie (280) above, however instead of a snapshot (b1), the video (c1) of the Visit taken with the Taker's device will be used, and instead of a stills selfie (b2), a video selfie (c2) of the Visitor, taken with the Visitor's device will be used. Then, video editing algorithms (c3) instead of image algorithms (b3) will be used to separate the Visitor's video image from the Visitor's video background and implant it on top of the Visit video (c1).
(d) Zoom In (295). Using this Take Over Icon the Visitor can zoom in with the Taker's camera, even with using an optical zoom or lenses' switch if exist at the Taker's device. It should be noted that, in addition, the visitor can zoom locally at the Visitor's device using a zoom fingers' motion on the Visitor's device touch screen. However, the Take Over zoom is a much more powerful option as it is done at the Taker's device, thus enabling a physical optical zoom based on the Taker device's lenses system rather than a digital zoom.
(e) Zoom Out (290). Similar to (295) above.
(f) EXT (305). This refers to a Take Over operation which operates an external device if exists at the taker's side. Here is an example which is also farther detailed at a separate patent application: A Taker will hold a special handle or stick, and the Taker's device will be attached to a mount at the edge of such handle. Said mount has certain degrees of freedom relative to the handle, allowing it to change its position relative to the handle. For example, to rotate 90 degrees or to tilt left and right or up and down. An electric motor or actuator is attached to the handle and it can control said positions, and such control is achieved via software that transmits said control instructions via wireless transition such as Bluetooth, that will be included in said handle's device. If the Takeataker app will be customized to interact with said handle via Bluetooth, then the Visitor will be able to execute the following process: (f1) The Visitor selects the EXT icon; (f2) The Visitor sees a list of available external devices; (f3) The Visitors selects said handle device from the list; (f4) The Visitor gets a control menu with Control Icons that can control the handle; (f4) The Visitor selects control operations via such control menu. For example: rotate 90 degrees. Another example: Tilt up; (f5) Said control operation is transferred from the Takeataker app at the Visitor's device to the Takeataker app at the Taker's device; (f6) Said control operation is transferred from the Takeataker app at the Taker's device to said electric motor or actuator of such external device of said handle via Bluetooth; and (f7) As a result said mount with the Taker's device attached to it changes its position relative to said taker's handle. In other words—the Visitor changed the orientation or the camera's direction of the Taker's device directly by a Take Over operation, without any involvement of the Taker, who is simply holding the handle during all that time.

It should be noted that external device could also be used at the Visitor's side according to the invention, in order to enhance the Visit. For example, the Visitor may use 3D glasses connected to the Visitor's device. This, of course, requires a Taker's device that supports 3D video capturing, and transmitting this 3D video streaming via the Takeataker servers.

The Take Over Icons and Post Processing Icons tab, also marked as “TO & POST” (340), as shown in FIG. 3B, also include in this example four icons which support additional operations by the Taker, described as Post Processing operations in this invention. Such Post Processing operations include the following options in this example:
(a) Filter (320). When the Visitor selects this option, a menu with filters appear. Such filters allow the Visitor to manipulate the Visit's video or snapshots or selfies. For example, the Visitor may wish to see and experience the streaming video in black and white, or in intensified pastel coloring. Such preference may intensify the emotional effect of the Visit for the Visitor. If, for example, the Visit is taken at the Visitor's childhood neighborhood, a black and white video or a 60's style colors gamma may add an artistic or an emotional element to the Visit's experience.
(b) REC (330). The Visitor turns on and off a video recording option. By default, according to this example, the entire Visit may be saved for later use by the Visitor.
(c) Share (325). The Visitor may, while in a Visit session, to immediately share a selfie or a snapshot etc., with other people via other applications.
(d) Empty icon (335). This is shown to illustrate the fact the GUI is customizable. The user, whether a Visitor or a Taker can add or remove specific icons associated with specific operation based on such user's preferences.

### Example 3

Example 3 includes Table 1 below, which demonstrates the variety and the reach use-cases of possible Takeataker Visits according to the invention. The Visit's Nature column is a title that categorize the nature of said Visit. The Description column provides details of said Visits. The Special Requests column shows activities which enhance and expand the nature of a Visit from a more passive Visit to a truly active by nature Visit in which very specific goals and tasks can be achieved according to the invention.

TABLE 1

| Visit's Nature | Description | Special Requests |
|---|---|---|
| Tour | I want to start my day in Champs-Elysees | |
| | Paris | |
| Roots | Today I want to see the street and the | Show me the house's front, back and |
| | house where I grew as a child | yard. |
| Social | I want to be at the protest in NYC | |
| involvement | tomorrow | |
| Culture | I must see this new exhibition in Getty | Allow me to focus on some pictures |
| | museum LA | and take snapshots, |
| Nostalgy | I want to re-live the walk in Oxford | Does Selfridge's coffee shop “Tea on |
| | street from Marble Arch to Selfridges | Two” at the second floor still exist? |
| | | Show me. |
| Preview | Show me the Bergen hotel where I was | Show me the lobby. I want to see if |
| | 25 years ago and plan to go again | the hotel looks as good as in the |
| | | hotel's site |
| Explore | I am going with my daughter to see this | Show me the parks at this area. Tell |
| | new neighborhood | me about the neighborhood. |
| Holiday | Tonight, I join the Independence Day | Show me the bands on the stage and |
| | celebration | the fireworks at 22:00 |
| Inquire | Show me this new dress collection at | Enter the shop, show me the items I |
| | Uniqlo shop in Boston downtown | find interesting and price tags |
| Curiosity | Tomorrow I walk in the streets of | |
| | Shenzhen, China | |
| Concierge | Show me the line for tickets at the | Wait and keep a place for me in the |
| | Strand | line. I will arrive in 30 minutes |
| Return | Let's see the streets of Edinburgh | Enter a few shops that I will show you. |
| | towards the castle, where we were last | Also show me a 360 panoramic view |
| | year | when you reach the top. |
| News | What is going on at Santa Monica beach | |
| | right now- Can anybody show me? | |
| Plan | Show me the campus of Amherst | Show me the dining options at the |
| | university, where my sun may apply | campus |
| Events | I want to see this street-event in NY | |
| | tomorrow. | |
| Festivals | Yes, I will be in Mardi gras 2021 and in | |
| | Rio 2021 | |
| Sports | How challenging is this bicycle trail in | Tell me about the weather conditions |
| | Winchester? Take me for a ride | as well. Do the trees provide |
| | | protection from the sun? |
| Participate | It will be a terrific Saint Patrick parade in | And I will take a lot of selfies and |
| | Dublin in two days - I must join | video selfies and share with my friends |
| Faith | Take me to the Western wall in | Dear taker, could you put a note with |
| | Jerusalem during the sunset. | a prayer in the stones of the wall? I |
| | | will send you the text in the chat. |
| Info | I am a journalist, show me the Times | Go back and forth in the square for at |
| | Square within the next hour | least 15 minutes and show me around |
| Assist | My aunt is not answering the phone - | Press the doorbell and if she answers |
| | take me to her home | let me talk to her. If not, please press |
| | | the doorbell of the neighbor next door |
| | | and let me talk to him. |
| Experience | End my day with a cup of tea while | |
| | viewing the sunset over the Golden Gate | |
| Parking | Find me a parking place near the | Keep the parking place for me and |
| | Palladium theatre at 19:00 | wait until I arrive |
| Shopping | Go to Barnes & Noble and see if there | Take a copy for me and wait for me in |
| | are any copies left of this new bestseller | the store |
| Real Estate | I'm looking for real estate opportunities | Tell me about the shopping options |
| | in Athens, show me new construction | and the schools' levels in the area of |
| | sites in the city. | such construction sites |
| Neighborhoods | My daughter is going to Liverpool for 3 | Tell me about these locations. Which |
| | months; show me these two | is nicer and safer? |
| | neighborhoods. | |
| Offices' lines | Show me the line to renew my driving | wait for me in the line until I arrive in |
| | licenses. | about 45 minutes |

### Example 4

Example 4 shows another method to initiate a Visit session with a Matched Visitor and a Matched Taker. Unlike Example 1 above, in which a visitor defines where he wants to be, what he wants to do, and at what date and time the visit needs to take place, in This Example 3 the visitor uses the Takeataker website to search for suggested Visits. Said suggested Visits are suggested by takers all over the world. Takers can suggest specific Visits according to such takers' geographic location as well as such taker's available time slots, preferences or areas of interests or fields of knowledge.

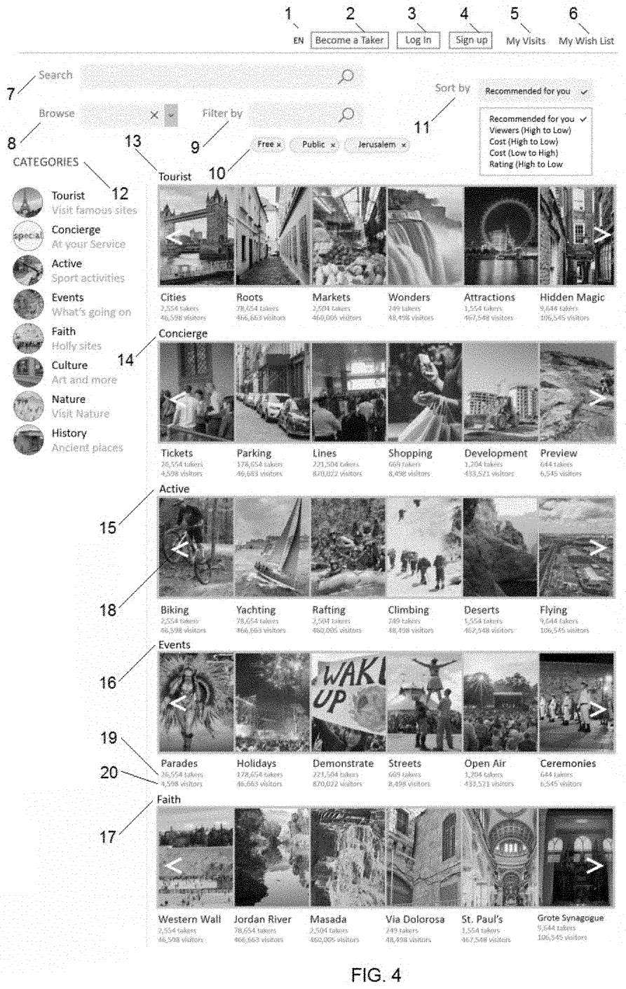

FIG. 4 shows an example of the Takeataker website. Therefore, some generic options are visible at the top of the page. Such generic options include, in this example, the ability to select language of the site (1); a direct access to sign up as a taker (2); a log in button for recurring visitors or takers (3); a sign up button to sign up for a first time as a visitor or as a taker or as both (4); a “My Visits” button which allows a user, once singed in, to view the history of such user's Visits and the list of future scheduled Visits; a “My Wish List” button in which a visitor can save a list of browsed suggested Visits for a later review.

The suggested Visits are arranged in a tree of categories (12) and sub-categories which, in this example, include the following:
(a) “Tourist” (13), with the following sub-categories according to this example:
   1. Cities
   2. Roots—places which are typically popular for roots' visits
   3. Markets—Famous or interesting markets
   4. Wonders—for example, Niagara Falls
   5. Attractions—for example, London Eye
   6. Hidden Magic—for example small allies and secret gardens in London, which are known to local takers.
(b) “Concierge” (14), with the following sub-categories according to this example:
   1. Tickets—Popular or busy lines to buy tickets. A taker may suggest to video stream the line and even to wait in the line until a Matched Visitor arrives.
   2. Parking—A taker may suggest to find street parking at busy places and busy times, e.g. neat theatres, to video stream the parking location, and to keep the parking and wait to the Matched Visitor, until said Visitor arrives and takes the said reserved parking slot.
   3. Lines—Similar to Tickets above, a taker may suggest standing in a line of any kind, e.g. a line to renew driving licenses, video stream such line, update a Matched Visitor via chat and voice conversation regarding the progress of the line, and wait in the line for said Matched Visitor until he arrives by himself and takes the saved position in the line.
   4. Shopping—A taker may suggest to visit stores, e.g. an Apple Store at the day of introducing a new product. The taker may video stream to the Matched Visitor from within the store, take a new arrival item and keep it for the Matched Visitor and wait until said Matched Visitor arrives to the store and takes said item which has been kept for him by the Taker.
   5. Development—A taker may suggest streaming videos to Matched Takers directly from construction sites to present the progress and the status of said sites during the time of the Visit. It could be a good way for Visitors who are looking, for example, to buy a new apartment overseas or even at the same country of said Visitor, and to see via a Takeataker Visit the up to date status of such construction sites of an apartment building.
   6. Preview—A taker may suggest preview of popular places, e.g. famous treks near the Himalaya. Matched Visitors may use this option to preview a trek, its level of difficulty, etc., as part of a decision making regarding the possibility to make such trek physically by themselves in the future. The Matched Visitor can also ask the Matched Taker to approach someone at the site and ask him something, or even ask such person if he's willing to talk directly to the Matched Visitor via the Takeataker video chat option.
(c) “Active” (15), with the following sub-categories according to this example:
   1. Biking—A Taker may take a Visitor to a Takeataker Visit in specific bike trails, in which the Mobility Mode is cycling. Matched Visitors may use this to get an impression of such trail and decide if they may want to be there physically by themselves in the future.
   2. Yachting. For example, a Taker can demonstrate operating a yacht, and Matched Visitors can experience the interior and the operation of said yacht, the process of entering or exiting a specific yacht harbor or the services within such harbor.
   3. Rafting—similar to cycling above, but for a route of rafting in a river.
   4. Climbing—Yet another sport activity that can be streamed using a Takeataker session.
   5. Deserts—Specific category for desert areas.
   6. Flying. Some possible subcategories of the Flying subcategory itself, may be:
      i. Real Airplane. In this category a taker suggests entering an airplane, whether as a pilot or as a passenger, and stream the views from the sky. This, again, can be farther divided to subcategories, e.g.:
         1. Agriculture—Flying with a small plan above fields
         2. City—Flying with a small plan above a city
      ii. Real Helicopter. Similar to Real Airplane above.
      iii. Drone. In this option the taker is not flying by himself, but he uses a drone. The Matched Visitor, which can be anywhere in the world during such Takeataker Visit, may see the streaming from the drone which the Matched Taker streams via the Takeataker app to the Matched Visitor. In other words, such Visitor is not limited to use his own drone within his own limited range of a few miles. Instead, a Visitor can use a Taker's drown for a real time streaming from places which are thousands of miles away, and even though the Visitor may not own a drone by himself.
(d) “Events” (15), with the following sub-categories according to this example:
   1. Parades.
   2. Holidays. For example, a taker may suggest participating in the New Year's Eve fireworks show over the river in Lucerne, Switzerland.
   3. Demonstrate. A taker may allow a Matched Visitor to participate a demonstration remotely via the Takeataker app.
   4. Streets. A taker may suggest a Takeataker session to be streamed from street events.
   5. Open Air. A taker may suggest a Takeataker session to be streamed from an open-air concert.
   6. Ceremonies.
(e) “Faith” (17). A taker may suggest Takeataker Visits to places with religious importance. A few sub-categories according to this example:
   1. The Western Wall
   2. Jordan River
   3. Masada
   4. Via Dolorosa
   5. St. Paul's cathedral
   6. Grote Synagogue

Arrows (18) in FIG. 4 indicate that there are more subcategories within the category, which can be seen by pressing the arrow. For example, by pressing said arrow, the “Active” category (15) may reveal a subcategory with the name “Trekking”. When entering each of said subcategories, additional subcategories may be available, until reaching the bottom of such tree's list which include specific activities. It should be noted that said specific activities may be accessible via several subcategories if applicable. For example, a specific trek in the Himalaya may be found under “Preview” which is a subcategory of “Concierge”, and it may also be found under “Trekking” which is a subcategory of “Active”.

Each subcategory shows the number of available takers (19) for said subcategory, and the number of visitors (20) already participated as Matched Visitors to Takeataker Visits in said category with said takers.

A visitor may browse available categories of said suggested Visits (8) and search the database of said suggested Visits using key words in the search field (7). In addition, search tags (10) can be browsed or enter to filter and narrow the search results. In this example the following search tags have been entered: (a) “Free”. This means that the visitor is looking for takers who offer Visits which are free of charge. It should be noted the advertisement may appear during free of charge Visits. In Visits which are not free there will be no need to add commercials because the Visitor pays for a Visit. In such paid Visit, some of the payment goes to the Taker and some of the payment goes to the Takeataker app and service owners; (b) “Public”. This means that the visitor wants to participate in a Takeataker Visit that, rather including one Matched taker and one Matched visitor, it includes one Taker and many Visitors, all participating and receiving the video streaming. For obvious reasons, there will be different rules for such event. For example, the Taker will be able to disable the Control Icons operations and the Take Over operations; (c) “Jerusalem”. This is the third and last search filter tag, in this particular example. As a result, the Visitor will receive a list of all public free events in Jerusalem which are suggested by takers. For example, a taker may offer a 30 minutes free public Takeataker Visit in a specific market in Jerusalem every Friday starting at 11:00 local time, in which the Visitors can see, hear and also fill the atmosphere in this Jerusalem market towards the upcoming weekend. If a Visitor wants to participate, he will be able to submit his registration and receive a confirmation, similar to example 1 above.

If a Visitor receives several suggestions for Takeataker Visits that match such visitor's search and filter preferences, the visitor will be able to sort such offers (11) based on various criteria such as “Recommended for you” which is based on previews Visits or wish list of such visitor; Number of viewers; Cost; Rating.

While some embodiments of the invention have been described by way of illustration, it will be apparent that the invention can be put into practice with many modifications, variations and adaptations, and with the use of numerous parameters that are within the scope of persons skilled in the art, without departing from the spirit of the invention or exceeding the scope of the claims.

1. A computer implemented method for remote or virtual visits over the internet, comprising the elements of:
a) A Matched Visitor's app running on said Visitor's device and enabling said Visitor to remotely and actively participate in a remote Visit;
b) A Matched Taker's app running on said Taker's device and enabling said Taker, who takes said Visitor to a Visit, to communicate with said Visitor and to live stream said Visit products to the Visitor;
c) A Server enabling a real time communication or a short delay communication between said Visitor's app and said Taker's app.

2. Method according to claim 1 where said Visitor's app includes Control Icons and said Taker's app provides visual indication resulting of operating said Control Icons at the Visitor's end.

3. Method according to claim 2 where sound or voice alerts are initiated at the Taker's app resulting of operating Control Icons at the Visitor's app.

4. Method according to claim 1 where said Visitor's app includes Take Over Icons and said Taker's app activates software and hardware element directly at the Taker's device as a result of operating said Take Over Icons at the Visitor's end.

5. Method according to claim 1 where said server includes a Video Analyzer which analyzes parameters of the video stream.

6. Method according to claim 5 which includes a Video Normalizer which improves the quality of said video, based on said Video Analyzer's analysis prior to forwarding said video to the Visitor's app.

7. Method according to claim 6 which includes an Analyzer, and such Analyzer provides feedback to the Matched Taker in order to enable the Taker to improve the quality of such Taker's video streaming.

8. Method according to claim 7 that uses the instructions provided by the Matched Visitor as part of the Analyzer's analysis.

9. Method according to claim 7 that uses sensors or orientation data at the Taker's device as part of the Analyzer's analysis.

10. Method according to claim 1 in which said Visit is initiated by said Visitor who defines the desired place and time of the Visit.

11. Method according to claim 10 in which additional requirements are included in the initiated Visit such as mobility mode or end point's location or duration or language or special requests for special activities to be fulfilled as part of said Visit.

12. Method according to claim 1 in which said Visit is suggested by said Taker and such suggestions can be browsed or filtered or searched and selected by said Visitor via said app or a dedicated website.

13. Method according to claim 2 in which said Control Icons include instructions to move forward or move backward or move left or move right or rotate device or stop or focus or cancel focus.

14. Method according to claim 4 in which said Take Over operations operate the taker device's camera.

15. Method according to claim 4 in which said Take Over operations operate an external device of the taker.
